(19) United States
(12) Patent Application Publication
(10) Pub. No.: US 2004/0175548 A1
(43) Pub. Date: Sep. 9, 2004

(54) Article having printed conductive ink

(76) Inventors: Daniel P. Lawrence, Ypsilanti, MI (US); Conalisa M. Murphy, Ypsilanti, MI (US)

Correspondence Address: HARNESS, DICKEY & PIERCE, P.L.C., P.O. BOX 828, BLOOMFIELD HILLS, MI, 48303, US

(21) Appl. No.: 10/805,984

(22) Filed: Mar. 22, 2004

Related U.S. Application Data
(62) Division of application No. 10/075,777, filed on Feb. 14, 2002.

(51) Int. Cl. B32B 3/00

(52) U.S. Cl. 428/195.1

(57) ABSTRACT

A conductive ink composition comprising a carboxylic acid- or anhydride-functional aromatic vinyl polymer, a conductive particulate material, and/or a conductive flake material (any material with an aspect ratio of at least about 5:1) may be printed in a thickness of five microns or less to provide sufficient conductivity for RFID tag antenna and other printed conductive and semi-conductive structures. Printing the ink by flexographic or gravure printing offers advantages over other printing methods previously used.

### CROSS-REFERENCE TO RELATED APPLICATIONS

This application is a divisional of U.S. patent application Ser. No. 10/075,777 filed on Feb. 14, 2002. The disclosure of the above application is incorporated herein by reference.

### FIELD OF THE INVENTION

The present invention concerns conductive flexographic and gravure inks, printing with these conductive inks, and the printed articles obtained by printing with these conductive inks.

### BACKGROUND

Conductive materials in electronic circuits are often applied by screen printing. In screen printing, the ink is forced through a mesh screen onto the substrate. A comparatively thick layer (on the order of 25 microns) of a silver-based, conductive material is applied by screen printing to a substrate.

One kind of device that has been printed with screen printing has been radio frequency identification (RFID) tags. The RFID tags use printed electronic circuits to store information about a product to which they are attached. The information can be used for inventory control, for example. The tag includes a semiconductor chip containing the information and printed antennae. The information on the tag may be accessed using radio frequency to generate a current across the central chip.

The screen-printed RFID antennae have relatively thick, black or silver print, depending upon whether the ink is made with conductive carbon pigment or silver. The high conductivity provided by silver connections is not necessary for capacitive RFID antennae, and the expense makes them undesirable. Black (or silver, if used) printed antennae interfere with the desired package graphics, primarily because of the color but also because of the thick print, which makes them texturally different from the remaining print on the package. For this reason, RFID tags for inventory control have been screen printed to the reverse side of packaging. The package is then flipped over, and graphics are printed on the outside of the package. In this way, the black or silver RFID tag does not interfere with the desired appearance of the graphics. The thicker print obtained with screen printing also adds to the cost.

Harrison et al., WO 97/48257, describe lithographically printing electrical circuits. The WO 97/48257 application describes lithographic printing using an electrically conductive ink, in which the ink has a high concentration of metallic silver, 65 to 95% by weight, or a corresponding concentration of another metallic particle, such as aluminum. The binder may be an alkyd resin, phenolic resin, hydrocarbon resin, turpene resin, or rosin. The application teaches that resin composition affects conductivity of the printed ink.

Lithographic printing, however has a number of shortcomings, particularly for packaging, in which RFID tags are of particular value. First, packaging is often printed on gravure and flexographic presses. To print the RFID tags lithographically would require purchase of a lithography press for that limited purpose. Secondly, the ability to control ink film thickness in lithographic printing is limited, so that it is difficult to control the conductivity of the printed area. In contrast, print thicknesses are easily controlled in flexographic and gravure printing by selection of the anilox screen or depth of the gravure cells. Thirdly, in some instances the conductive ink will have a high loading of conductive material. Lithographic printing plates tend to wear quickly, resulting in toning (printing in non-image areas) when printing high solids inks. Furthermore, lithography is much more limited in the types of substrates that can be printed as compared to flexography and gravure printing. Finally, the lithographic printing process is much more limited as to the kinds of solvents the inks can be formulated with. Solvents in lithographic inks must not swell or damage the rubber parts of the press, and cannot interfere with the separation of ink and fountain solution on the printing plate. Thus, waterborne inks are not used in standard lithographic printing, and can only be carried out using special, expensive plates in which the non-image areas are specially coated.

It would be desirable to be able to print a thinner, conductive print, both for better economy and to make the RFID tag less conspicuous. It would further be desirable to print a thinner print in a color compatible with the printed graphics. Furthermore, gravure printing inks and flexographic printing inks overcome several problems associated with lithographic printing inks, particularly for applying RFID tags to packaging.

### SUMMARY OF THE INVENTION

The conductive ink of the invention, suitable for gravure or flexographic printing, includes a carboxylic acid- or anhydride-functional aromatic vinyl polymer and an electrically conductive material that may be either a particulate material or a flake material, particularly a conductive flake material having an aspect ratio of at least about 5:1. “Flake material” is used expansively to include all kinds of materials having such aspect ratios, including fibers, particularly carbon fibers and fibers coated with conductive materials. The conductive ink provides print with usefully high conductively at lower thickness. “Conductive” as used herein refers to electrically conductive.

The invention further provides a method for printing an electrically conductive print by flexographic or gravure printing. The ink of the invention may be applied in a desired design or array by these methods in a desired film thickness, especially 5 microns or less.

The invention still further provides articles printed with the conductive ink of the invention, including, without limitation, electrical circuitry including printed circuit board circuitry and battery interconnect circuitry, microwave integrated circuits, including microwave antennae, planar antennae, contoured antennae, capacitive RFID tags, packages including RFID tags, electrostatic detection devices, and articles having printed anti-static solid areas or arrays of the conductive ink.

The invention overcomes the difficulties of earlier inks and printing methods. The inks of the invention can be printed using the same equipment used to print the package graphics, and these printing processes are able to handle many more kinds of substrates than lithographic processes. The inks and printing processes of the invention can be printed with more control of ink film thickness, and thus control of the conductivity of the printed area. High loadings of conductive material for printing highly conductive print can be accommodated without wear on flexography or gravure press equipment. Finally, the inks of the invention can be aqueous and do not special, expensive equipment for printing the aqueous inks.

### BRIEF DESCRIPTION OF THE DRAWINGS

The present invention will become more fully understood from the detailed description and the accompanying drawings, wherein:

FIG. 1 is a cross-sectional side view of a preferred embodiment of the invention;

FIG. 2 is a top view of an embodiment of the invention.

FIG. 3 is a top view of a portion of the embodiment of FIG. 1.

FIG. 4 is a topview of an article printed by the process of the invention.

### DETAILED DESCRIPTION OF THE PREFERRED EMBODIMENTS

The following description of the preferred embodiment(s) is merely exemplary in nature and is in no way intended to limit the invention, its application, or uses.

The conductive ink of the invention includes a carboxylic acid- or anhydride-functional aromatic vinyl polymer and a conductive material that may be a particulate material, a flake material, preferably having an aspect ratio of at least about 5:1, or a combination of these. The carboxylic acid- or anhydride-functional aromatic vinyl polymer may be prepared by polymerizing a monomer combination comprising an aromatic vinyl compound. Examples of suitable aromatic vinyl compounds include, without limitation, styrene, α-methyl styrene, dimethyl styrene, vinyl toluene, tert-butyl styrene, vinyl benzoate, and combinations of these. Styrene copolymers are particularly preferred.

The aromatic vinyl compound or compounds may be copolymerized with at least one carboxylic acid- or anhydride-functional ethylenically unsaturated monomer. Examples of such monomers include, without limitation, acrylic acid, methacrylic acid, crotonic acid, maleic acid, maleic anhydride, and combinations of these. Maleic anhydride is particularly preferred. In a preferred embodiment the polymer is a styrene-maleic anhydride copolymer. In another preferred embodiment, the polymer is a copolymer of styrene, acrylic and/or methacrylic acid, and, optionally, other copolymerizable monomers.

The carboxylic acid- or anhydride-functional aromatic vinyl polymer preferably includes up to about 20% by weight, preferably up to about 15% by weight, and more preferably up to about 2% by weight of additional comonomer units. Examples of suitable comonomer units include, without limitation, those provided by polymerization of acrylonitrile, methacrylamide, acrylic and methacrylic esters such as methyl methacrylate, butyl acrylate, 2-ethylhexyl methacrylate, and butyl methacrylate; hydroxyl functional monomer such as hydroxyethyl acrylate, hydroxyethyl methacrylate, hydroxypropyl acrylate, hydroxypropyl methacrylate, and vinyl alcohol (polymerized as the acetate and then hydrolyzed to form the alcohol);

The vinyl polymer preferably has a weight average molecular weight of from about 10,000 to about 50,000, more preferably from about 20,000 to about 40,000.

The carboxylic acid- or anhydride-functional aromatic vinyl polymer is dissolved or dispersed in a suitable solvent for the ink. Preferably, the ink is aqueous, and the carboxylic acid or anhydride-functional aromatic vinyl polymer may be prepared in water, e.g., by emulsion polymerization, or may be dispersed in water after polymerization. It should be realized that polymerizing or dispersing an anhydride group in water will result in formation of the corresponding acid.

Preferably the carboxylic acid- or anhydride-functional vinyl polymer may have an acid number in the range of about 0.5 to about 100 mg KOH/g, more preferably from about 0.5 to about 50 mg KOH.g. In general, when the acid number increases, the ink is more stable when run on press. When the conductive material includes carbon black, increasing acid number may result in higher viscosities at the desired carbon loading. When the conductive material includes carbon black, then, the carboxylic acid- or anhydride-functional vinyl polymer preferably has an acid number of from about 0.5 to about 15, preferably from about 1.5 to about 10, and still more preferably from about 7.5 to about 9.5 mg KOH/g. When used in an aqueous ink composition, the polymer particularly preferably has an acid number of from about 7.5 to 8.5 mg KOH/g and is salted with ammonia or an amine, especially a tertiary amine such as dimethylethanolamine, to a pH of 7 or higher, preferably a basic pH, more preferably a pH of from about 8 to about 9.

The carboxylic acid- or anhydride-functional aromatic vinyl polymer is preferably about 40% to 100%, more preferably about 45% to about 55% by weight of the total weight of polymers and resins in the ink.

The ink preferably includes one or more further polymers or resins, such as an acrylic polymer or nitrocellulose polymer. Other useful polymers include other cellulosic resins, for example cellulose acetates and cellulose mixed esters such as acetate propionates and acetate butyrates, poly(vinyl butyral) polymers, maleic-modified rosin esters, polyamides, and styrene-allyl alcohol copolymers (SAA). The further polymers or resins are preferably up to about 30% by weight, more preferably from about 15% to about 25% by weight, based on total polymer and resin weight [“total binder weight”] in the ink.

The conductive ink further includes at least one conductive material, which may be a particulate material and/or conductive flake material having an aspect ratio of at least about 5:1. The average particle size of the conductive particulate material is preferably up to about 15 microns, more preferably up to about 3 microns. One preferred conductive particulate material is carbon black, particularly conductive acetylene blacks. The carbon black may be dispersed in the carboxylic acid or anhydride-functional aromatic vinyl polymer, dispersed using another dispersing resin or polymer, or dispersed with a dispersant.

The conductive particulate material may also be a conductive metal oxide material. Suitable conductive metal oxide materials include antimony tin oxide and indium tin oxide powders and other particulate materials, specifically pigments or fillers, coated with antimony tin oxide and/or indium tin oxide. These conductive metal oxide materials are particularly desirable for producing conductive inks that are not black. The metal oxide materials have a light gray color and may formulated into an ink of nearly any color. Suitable particulate materials that may be coated with the conductive metal oxide materials include, without limitation, titanium dioxide and silicon dioxide particles.

Another kind of suitable conductive particulate material is metal particles. Examples of preferred conductive metal particulates include, without limitation, metals in Group IV of the periodic table, metallic silver, metallic aluminum, metallic copper, and the like, conductive alloys such as bronze, as well as other particulate materials coated with such metals.

In general, the conductive particulate material may be included in an amount of from about 10 to about 90% by weight, based on the total binder weight. The preferred amount depends upon the type of conductive particulate material being used and the level of conductivity desired in the print. For example, a higher amount by weight of a denser particulate material, such as silver powder, would be used as compared to a material with low density, such as carbon black. Further, a higher conductivity can be achieved using silver materials as compared to carbon black materials. Metal powders are included in an amount preferably of from about 60 to about 95% by weight, more preferably about 65 to about 85% by weight, based on the total binder weight. Carbon black and conductive metal oxide powders are preferably included in an amount of from about 10 to about 95%, more preferably from about 10 to about 50%, based on the total binder weight. When combined with a carbon-based conductive flake material and/or a conductive metal oxide-based conductive flake material, carbon black and conductive metal oxide powders are preferably included in an amount of from about 10 to about 35%, more preferably from about 15 to about 25%, based on the total binder weight.

The ink may contain a conductive flake material instead of, or in addition to, the conductive particulate material. In general, the flake material is a conductive material having an aspect ratio of at least about 5:1, preferably from about 10:1 to about 50:1. Examples of suitable conductive material having an aspect ratio of at least about 5:1 include, without limitation, graphite, carbon fiber (which may have an aspect ratio of up to about 10,000:1), mica coated with antimony tin oxide, mica coated with indium tin oxide, mica coated with antimony tin oxide and indium tin oxide, micas such as these having intermediate layers of titanium dioxide or other inorganic or organic compounds and outer layers of antimony tin oxide and/or indium tin oxide, metallic flakes such as silver flakes, copper flakes, and aluminum flakes, flakes of conductive alloys such as bronze flakes, micas having an outer layer of silver, copper, aluminum or other conductive metal or metal alloy, and combinations of these.

In general, the conductive flake material may be included in an amount of from about 10 to about 95% by weight, based on the total binder weight, again depending upon the type of conductive flake material being used and the level of conductivity desired in the print. A metallic flake is preferably included in higher amounts by weight, preferably from about 60 to about 95% by weight, more preferably about 65 to about 85% by weight, based on the total binder weight. Graphite, conductive carbon fibers, and/or metal oxide conductive flake materials are included in an amount of preferably from about 5% to about 60% by weight, more preferably from about 5 to about 40% by weight, still more preferably from about 10 to about 30% by weight, based on the total binder weight.

In a preferred embodiment, the ink contains both a conductive particulate material and a conductive flake material. The weight ratio of conductive particulate material to the conductive flake material is preferably from about 1:1 to about 2:3. The ink composition preferably has a pigment weight to binder weight ratio of from about 0.1:1 to about 1:1, preferably from about 0.3:1 to about 0.5:1. It is especially preferred for applications that do not require a high conductivity, for example for capacitive RFID antennae, that the conductive particulate material is selected from carbon black, conductive metal oxide materials including particulate antimony tin oxide, particulate indium tin oxide, particulate pigments or fillers, coated with antimony tin oxide and/or indium tin oxide, including, without limitation, titanium dioxide and silicon dioxide particles coated with antimony tin oxide and/or indium tin oxide, and combinations of these; and that the conductive flake material is selected from carbon-type flakes such as graphite, carbon fibers, carbon-coated flake materials, micas coated with antimony tin oxide and/or indium tin oxide, optionally with intermediate layers of titanium dioxide or other inorganic or organic nonconductive or conductive compounds. For other applications, such as backscattered RFID tags, the conductive particulate and/or conductive flake materials may be selected from higher conductivity materials, such as metals, metal alloys, and materials coated with metals or metal alloys, example of which include, without limitation, silver particles, silver flakes, copper particles, copper flakes, bronze flakes, and combinations of these.

The ink may also contain a colorant, which may be a dye, but typically is a pigment, whether an organic pigment or an inorganic pigment, or any combination of these. The pigments are preferably dispersed by the polymer in the ink, preferably by at least a part of the further polymers mentioned, especially nitrocellulose polymer. The ink may also include a dispersing agent or dispersing resin, which may be ionic or nonionic in an aqueous ink. The ink composition, or a part of the materials used in the ink composition, may be sheared, for example in a mill, to reduce the particle size of the pigment to not more than about 1 micron. Virtually any organic or inorganic color pigment may be included. Examples of suitable classes of organic pigments that may be used include, without limitation, metallized azo pigments like lithol rubine and non-metallized azo pigments like naphthol reds, azomethine pigments, methine pigments, anthraquinone pigments, phthalocyanine pigments, perinone pigments, perylene pigments, diketopyrrolopyrrole pigments, thioindigo pigments, iminoisoindoline pigments, iminoisoindolinone pigments, quinacridone pigments such as quinacridone reds and violets, flavanthrone pigments, indanthrone pigments, anthrapyrimidine pigments, carbazole pigments, monoarylide and diarylide yellows, benzimidazolone yellows, tolyl orange, naphthol orange, and quinophthalone pigments. Examples of suitable inorganic pigments include, without limitation, metal oxide pigments such as titanium dioxide, iron oxides including red iron oxide, black iron oxide, and brown iron oxide; carbon black; ferric ferrocyanide (Prussian blue); ultramarine; and so on.

The ink compositions of the invention may also include other components, including fillers such as clay, defoamers, biocides, and so on, so long as these do not interfere with the conductivity of the printed ink.

The conductive ink may be printed onto a substrate by gravure printing or flexographic printing. Solvents that may be used in the ink compositions of the invention include, without limitation, water, methanol, ethanol, propanol, isopropanol, butanol, isobutanol, sec-butanol, tert-butanol, diacetone alcohol, butyl glycol, methyl acetate, ethyl acetate, propyl acetate, isopropyl acetate, butyl acetate, isobutyl acetate, aliphatics such as heptane, cyclohexane, and toluene, glycol ethers such as propylene glycol monomethyl ether and other propylene glycol ethers, ethylene glycol ethers such as ethylene glycol monobutyl ether, and ethylene and propylene glycol ether acetates, N-methyl-2-pyrrolidone, ketones such as cyclohexanone, methyl ethyl ketone and isobutyl ketone, and combinations of these. Water and/or slower evaporating solvents are used in the ink for flexographic printing as compared to the solvents used in the ink for gravure printing. As is known in the art, the type and amount of solvent or solvents can be adjusted to optimize printing for the particular press, press speed, color strength desired, and so on.

The ink is preferably printed by flexographic printing, which uses a relatively fluid ink and a soft and flexible printing plate. Ink is applied to the surface of the printing plate with a screened (Anilox) roller. A conventional flexographic press includes an inking unit, a plate cylinder, and an impression cylinder. The inking unit meters out a thin film of the ink onto the surface of the printing plate. In a basic inking unit, a fountain roller partially immersed in a trough of ink carries a thin layer of ink into contact with the screen (Anilox) inking roller. In an alternative embodiment, ink may be metered onto the Anilox screen inking roller from an enclosed chamber unit. The ink in the cells of the inking roller is then transferred onto the printing plate of the plate cylinder. The plate cylinder rotates to bring the inked surface of the plate into contact with the web being printed. An opposing impression roller forms a nip with the plate cylinder through which the web passes. The impression roller presses the web against the printing plate so that the web takes up the ink from the printing plate. Typical printing plates are rubber plates and photopolymer plates. The three basic configurations of flexographic presses are stack, common impression, and in-line configurations. These are well known in the printing art and need not be described further here.

The conductive ink may also be printed by the gravure printing process. The gravure process uses a cylinder printing member onto which the printing image has been engraved in cells that become filled with the ink. The substrate is printed by passing the substrate between the engraved gravure cylinder and a second, impression roller that applies pressure. In a typical gravure press arrangement, there is a separate station for each color. After printing with each color, the web passes through a heated drying tunnel to dry each printed ink before the next color is printed over it.

Examples of substrates that may be printed with the conductive ink of the invention include, without limitation, films of polyalkylenes, particularly polypropylene and polyethylene, including corona treated films of these; polyesters, including poly(ethylene terephthalate); ethylene copolymers, including poly (ethylene-vinyl acetate) and poly (ethylene-vinyl alcohol); nylons; polyurethanes; fluorocarbon polymers; polyacrylonitrile; cellulosic polymers; coated and uncoated paper stock; synthetic papers; paperboard; polystyrene; poly(vinyl chloride); coated films such as acrylic and poly(vinylidene chloride) coated films; polycarbonates; metallized polymer films; and combinations of these, including multi-ply films having a layer of one of these materials and one or more layers of a different composition selected from these materials.

A preferred black ink has a sheet resistance of 200 when printed on a 80 pound—(120 grams per square meter—) weight coated stock. Non-black, color inks of the invention should have a sheet resistance of 50,000 ohms per square or less at about 5 microns, preferably 10,000 ohms per square or less at about 5 microns, printed on the same stock. The ink provides an advantage over previously used compositions because it achieves the desired conductivity at a thinner film. Print thicknesses of from about 2 to about 5 microns are preferred.

When the conductive ink is printed as a half-tone as part of the graphics design, it may be desirable to provide a conductive primer coat under the area of the conductive ink to boost its conductivity. The primer coat may have the same composition as the ink of the invention, but preferably with little or no pigment other than conductive metal oxide materials. The primer coat serves to provide greater electrical connectivity for the half-tone printing.

The print and any surrounding graphics may be coated with a protective coating. The protective coating may also be used to provide a glossy finish. Any of the known coatings may be useful for these purposes.

The conductive ink may be used to print antennae for RFID tags. In one such application, a pattern of conductive ink is printed on an internal surface, external surface, or on an inner face of a layer in a laminate structure. The pattern preferably includes two printed halves separated by a non-printed space. A capacitive RFID chip is placed across the gap between the antennae and may be held in place with, e.g., an adhesive. The adhesive may also be conductive.

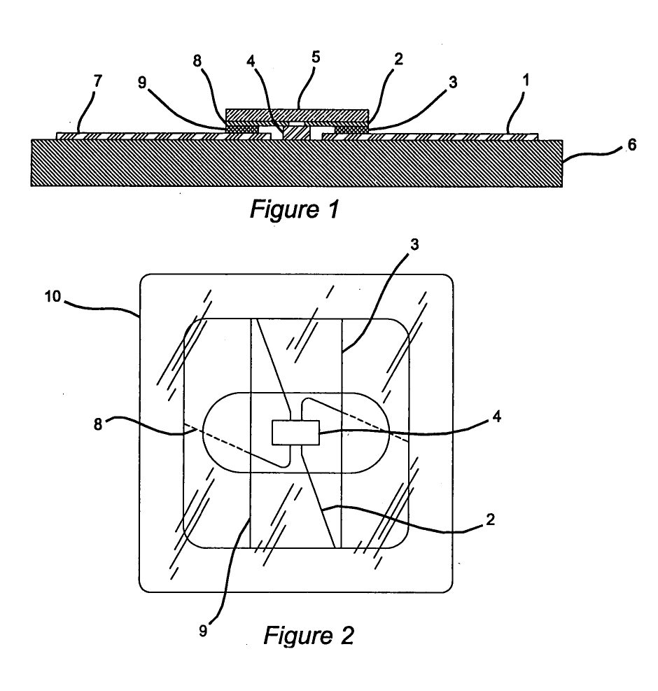

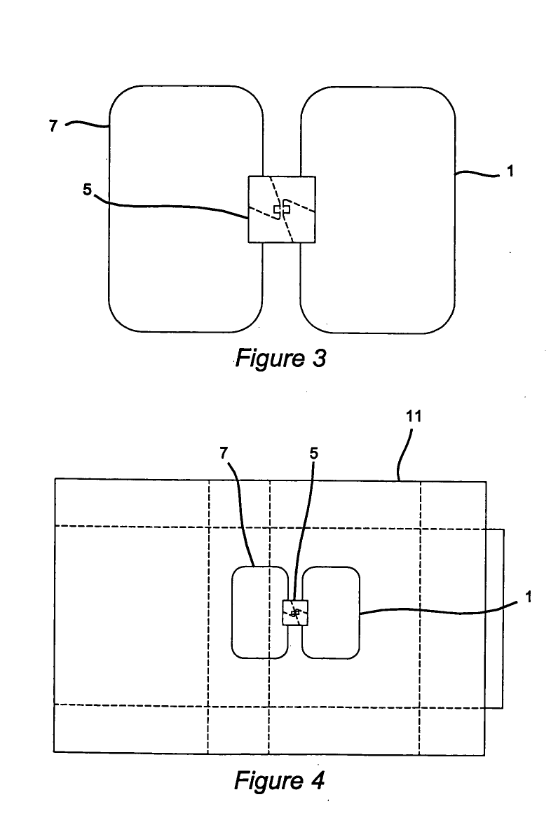

Referring now to FIG. 1, a substrate 6 such as paperboard is printed with conductive ink in two areas 1 and 7. A paper 5 having thereon areas 2 and 8 printed with conductive ink and bridged by electronic chip 4 is applied to the printed substrate and adhere by conductive adhesive areas 3 and 9, which contact the areas 1 and 7 on one side and the areas 2 and 8 on the other side. FIG. 2 show a top view of the paper 5 having areas 2 and 8 printing with conductive ink, conductive adhesive areas 3 and 9 overlaying the conductive ink areas, and a removable protecting layer 10, shown as transparent, which may be for example a polyethylene film, as the uppermost layer. FIG. 3 shows a top view of the chip assembly applied over the printed antennae. Paper 5, having on its underside the chip, conductive ink areas and conductive adhesive, is applied over antennae areas 1 and 7 printed with conductive ink. Finally, FIG. 4 shows one possible use of the conductive ink as a part of an RFID tag applied to packaging. Package substrate 11 is printed with conductive ink in areas 1 and 7. A paper label 5, having on its underside the conductive ink areas, conductive adhesive, and chip, is applied chip-side down bridging the conductive ink areas 1 and 7.

The conductive ink may be used for printing other conductive and semi-conductive structures, for example, without limitation, electrostatic sensors, electrodes of semiconductor circuits, electrical and electronic circuitry, parts of electrical and electronic components, parts of printed circuit boards, electrical interconnects, and so on. The desired conductivity of the printed layer can be achieved by selection and combination of conductive materials. Conductivity can be increased by including more conductive materials, by combining flake and particulate conductive materials, by increasing the loading of the conductive materials in the ink relative to the ink vehicle, by including metallic conductive materials or increasing the amount of metallic conductive materials relative to nonmetallic conductive materials, and by combinations of such changes. In this way, inks can be prepared with a conductivity suitable for a desired application.

For example, the conductive ink may have a high conductivity by including metallic conductive materials, such as copper and/or silver particles and/or flakes, and be used to print circuitry or components of printed circuit boards. The circuit board may include one or more electrical components and a conductive component fixative binding such components to the electrical circuit. The component fixative may include a metal-loaded or conductive adhesive. The substrate circuit board may be of any suitable material. Rigid circuit boards, such as fiber-reinforced laminates, including the widely-used glass fiber and paper materials impregnated with epoxy resins, may conveniently be printed by either flexographic or gravure printing.

Passive electrical components, including, without limitation, resistors, capacitors, and inductors, may be prepared with printed layers of the conductive ink. Capacitors can be formed by printing one layer of conductive ink, overlaying or overprinting with a dielectric material, then printing a second layer of the conductive ink to form a structure having two conductive layers sandwiching a dielectric layer. The dielectric layer may also be applied by gravure or flexographic printing. For example, a gravure or flexographic ink containing the acid-functional aromatic vinyl polymer and a dielectric particulate material such as barium titanate may be used.

The ink of the invention is illustrated by the following example. The example is merely illustrative and does not in any way limit the scope of the invention as described and claimed. All parts are parts by weight unless otherwise noted. Example.

A high speed mixer was used to blend 29 parts by weight of SMA 17352 (25% nonvolatile by weight, pH=9.1, available form Atofina) and 0.74 parts by weight of a thickener. Next were added, with mixing, 8.11 parts by weight of Joncryl 74 (48.5% nonvolatile by weight, available from Johnson Polymer), Joncryl 646 (60% nonvolatile by weight, available from Johnson Polymer), 3.2 parts by weight additives, 43.52 parts by weight of a carbon black dispersion (40% carbon black by weight, total nonvolatile weight about 48.5%), and 15 parts by weight graphite. The materials were mixed for 20 minutes, then ground on an Eiger Mill to a particle size of below 1 micron. A 100-gram portion was reduced with water to a viscosity of 13 seconds at 25° C. on a #3 Zahn cup.

The ink was proofed. Using an eyedropper and a 165-line hand proofer, 3 or 4 drops of the reduced ink were placed between the Anilox and durometer roller and then drawn down on uncoated craft paper. The print was gently dried with heat.

To measure the resistance, a 40 mm long by 4 mm wide section of print was made using two passes of a 100-line (23.6 BCM) hand proofer laid flat on a non-conductive surface. The two electrodes of an ohmmeter were placed at either end of the long axis of the section of print. The measured resistance value, in ohms, was divided by 10 to provide the sheet resistance value of about 200 ohms per square.

The ink was then diluted with water to 45 seconds on a Zahn #2 cup and printed using a flexographic printing press to form an antenna pattern having two identical halves separated by a gap of 4 mm. A self-adhesive label containing a Motorola Bistatix chip was applied across the gap such that the chip formed a bridge of electrical contact between each half of the antenna. This assembly was then place in the proximity of a Bistatix reader, which emitted an audio response indicating that the identification number of the chip had been correctly identified via radio frequency communication between the reader and the chip.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An article, comprising a printed layer of an ink comprising a carboxylic acid- or anhydride-functional aromatic vinyl polymer and a conductive material selected from the group consisting of conductive particulate materials, conductive flake materials, and combinations thereof.

2. An article according to claim 1, wherein the printed layer has a thickness of 5 microns or less.

3. An article according to claim 1, wherein the article comprises an RFID tag comprising as the printed layer an antenna.

4. An article according to claim 1, wherein said article comprises an electrostatic detection device comprising said printed layer.

5. An article according to claim 1, wherein said article comprises an anti-static solid area printed with said ink.

6. An article according to claim 1, wherein said article comprises an anti-static array printed with said ink.

7. An article according to claim 1, wherein the design is coated with a protective coating.

8. An article according to claim 1, wherein the design comprises at least one color other than black.

9. An article according to claim 1, wherein the design is printed in half-tone over a conductive primer coat.
